(19) United States
(12) Patent Application Publication
(10) Pub. No.: US 2025/0293260 A1
(43) Pub. Date: Sep. 18, 2025

(54) ELECTRODE MIXTURE, ELECTRODE LAYER, AND BATTERY

(71) Applicant: TOYOTA JIDOSHA KABUSHIKI KAISHA, Toyota-shi (JP)

(72) Inventor: Hideaki WATANABE, Nisshin-shi (JP)

(73) Assignee: TOYOTA JIDOSHA KABUSHIKI KAISHA, Tokyota-shi (JP)

(21) Appl. No.: 19/072,649

(22) Filed: Mar. 6, 2025

(30) Foreign Application Priority Data
Mar. 12, 2024 (JP) 2024-038134

(51) Int. Cl. H01M 4/62; H01M 4/02; H01M 10/0562

(52) U.S. Cl. CPC H01M 4/625; H01M 10/0562; H01M 2004/021; H01M 2004/028; H01M 2300/0068

(57) ABSTRACT

An electrode mixture contains an electrode active material, and fibrous carbon as a conductive material. In a case where a specific surface area of the fibrous carbon is X m²/g and a solid content ratio of the fibrous carbon in the electrode mixture is Y mass %, a product of the X and the Y is greater than 42 and smaller than 2200, and the Y is 2.0 mass % or less.

### CROSS-REFERENCE TO RELATED APPLICATION

This application claims priority to Japanese Patent Application No. 2024-038134 filed on Mar. 12, 2024. The disclosure of the above-identified application, including the specification, drawings, and claims, is incorporated by reference herein in its entirety.

### BACKGROUND

### 1. Technical Field

The present disclosure relates to an electrode mixture, an electrode layer, and a battery.

### 2. Description of Related Art

In recent years, the development of a battery has been actively performed. For example, in the automobile industry, a battery used for a battery electric vehicle (BEV), a plug-in hybrid electric vehicle (PHEV), or a hybrid electric vehicle (HEV) is being developed. An electrode layer used for the battery usually contains an electrode active material and may further contain a conductive material that improves electron conductivity.

For example, Japanese Unexamined Patent Application Publication No. 2023-109298 (JP 2023-109298 A) discloses a positive electrode including a positive electrode current collector, an adhesive layer, and a positive electrode layer in this order. Further, J P 2023-109298 A discloses that the positive electrode layer contains a positive electrode active material and further contains spherical carbon and fibrous carbon as a conductive material. Meanwhile, Japanese Unexamined Patent Application Publication No. 2022-156238 (JP 2022-156238 A) discloses a positive electrode layer containing S, Li₂S, P₂S₅, and a single-walled carbon nanotube.

### SUMMARY

A conductive material has a function of improving electron conductivity in an electrode layer and reducing resistance in the electrode layer. Meanwhile, when a conductive material having high electron conductivity reacts with an electrolyte, the electrolyte is electrochemically deteriorated. Therefore, in particular, when a content of the conductive material in the electrode layer is high, resistance in the electrode layer is likely to increase over time. On the other hand, in a case where the content of the conductive material in the electrode layer is low, it is difficult to sufficiently reduce initial resistance in the electrode layer.

The present disclosure provides an electrode mixture capable of reducing initial resistance in an electrode layer even when a content of a conductive material in the electrode layer is reduced.

An electrode mixture contains an electrode active material, and fibrous carbon as a conductive material. In the electrode mixture, in a case where a specific surface area of the fibrous carbon is denoted by X (m²/g) and a solid content ratio of the fibrous carbon in the electrode mixture is denoted by Y (mass %), a product of the X and the Y is greater than 42 and smaller than 2200, and the Y is 2.0 mass % or less.

In the electrode mixture of the aspect, the product of the X and the Y may be greater than 120 and smaller than 2000.

In the electrode mixture of the aspect, the X may be 350 m²/g or more.

In the electrode mixture of the aspect, the fibrous carbon may be a single-walled carbon nanotube.

In the electrode mixture of the aspect, the electrode mixture may further contain a solid electrolyte.

In the electrode mixture of the aspect, the electrode active material may have a layered rock salt crystal structure.

Another aspect of the present disclosure provides an electrode layer. The electrode layer contains the electrode mixture of the above aspect.

In the electrode layer of the aspect, a filling ratio of the electrode layer may be less than 93%.

In the electrode layer of the aspect, a filling ratio of the electrode layer may be 75% or more.

In the electrode layer of the aspect, the electrode layer may be a positive electrode layer.

Another aspect of the present disclosure provides a battery. The battery includes a positive electrode layer, a negative electrode layer, and an electrolyte layer. The electrolyte layer is disposed between the positive electrode layer and the negative electrode layer. The positive electrode layer or the negative electrode layer is the electrode layer of the above aspect.

In the battery according to the aspect, the electrolyte layer may contain a solid electrolyte.

In the battery according to the aspect, the positive electrode layer may be the electrode layer.

Another aspect of the present disclosure provides a manufacturing method of an electrode layer. The manufacturing method includes a preparation step and a pressing step. The preparation step is a step of preparing the electrode mixture of the above aspect. The pressing step is a step of pressing the electrode mixture at a temperature of 0° C. or higher and 30° C. or lower to obtain the electrode layer.

In the manufacturing method according to the aspect, a filling ratio of the electrode layer may be less than 93%.

In the manufacturing method according to the aspect, a filling ratio of the electrode layer may be 75% or more.

The electrode mixture according to the present disclosure have an effect of reducing the initial resistance in the electrode layer even when the content of the conductive material in the electrode layer is reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional view illustrating a battery according to the present disclosure; and

FIG. 2 is a flowchart illustrating a manufacturing method of an electrode layer according to the present disclosure.

### DETAILED DESCRIPTION OF EMBODIMENTS

Hereinafter, an electrode mixture, an electrode layer, a battery, and a manufacturing method of the electrode layer according to the present disclosure will be described in detail.

### A. Electrode Mixture

The electrode mixture according to the present disclosure contains an electrode active material, and fibrous carbon as a conductive material, in which, in a case where a specific surface area of the fibrous carbon is denoted by X (m²/g) and a solid content ratio of the fibrous carbon in the electrode mixture is denoted by Y (mass %), a product of the X and the Y is greater than 42 and smaller than 2200; and the Y is 2.0 mass % or less.

According to the present disclosure, the product of the X and the Y is within a predetermined range, whereby an electrode mixture is provided, in which an initial resistance in the electrode layer can be reduced even when a content of the conductive material in the electrode layer is reduced. As described above, the conductive material has a function of improving electron conductivity in the electrode layer and reducing the resistance in the electrode layer. Meanwhile, when a conductive material having high electron conductivity reacts with an electrolyte, the electrolyte is electrochemically deteriorated. Therefore, in particular, when the content of the conductive material in the electrode layer is high, the resistance in the electrode layer is likely to increase over time. On the other hand, in a case where the content of the conductive material in the electrode layer is low, it is difficult to sufficiently reduce the initial resistance in the electrode layer. This is because it is difficult to sufficiently secure an electron conduction path in the electrode layer. Regarding this, in the present disclosure, the fibrous carbon is adopted as the conductive material, and the specific surface area X and the solid content ratio Y (content) of the fibrous carbon are focused on, and the product of the specific surface area X and the solid content ratio Y is set within the predetermined range, whereby it is possible to reduce the initial resistance in the electrode layer even when the content of the conductive material in the electrode layer is reduced.

### 1. Fibrous Carbon

The fibrous carbon according to the present disclosure functions as the conductive material. In addition, in the present disclosure, the specific surface area of the fibrous carbon is denoted by the X (m²/g), and the solid content ratio of the fibrous carbon in the electrode mixture is denoted by the Y (mass %). As will be described later, the electrode mixture may contain a dispersion medium or may not contain a dispersion medium. A proportion of the fibrous carbon in the electrode mixture greatly varies depending on the presence or absence of the dispersion medium. Therefore, in the present disclosure, the proportion of the fibrous carbon in the electrode mixture is defined as a solid content ratio. In addition, the specific surface area according to the present disclosure can be obtained by the BET method.

The product (XY) of the X and the Y is usually greater than 42 and smaller than 2200. The XY may be 100 or greater, may be greater than 120, may be 150 or greater, may be 180 or greater, or may be 200 or greater. The XY may be 2100 or smaller, 2000 or smaller, 1500 or smaller, 1000 or smaller, 800 or smaller, or 600 or smaller.

The X may be, for example, 350 m²/g or more, 400 m²/g or more, 800 m²/g or more, 1,200 m²/g or more, 1,400 m²/g or more, 1,600 m²/g or more, 1,800 m²/g or more, or 2,000 m²/g or more. Meanwhile, the X is, for example, 2,600 m²/g or less.

The Y is usually 2.0 mass % or less, and may be 1.5 mass % or less, 1.0 mass % or less, 0.7 mass % or less, 0.5 mass % or less, 0.3 mass % or less, or 0.2 mass % or less. Meanwhile, the Y is, for example, 0.01 mass % or more.

A diameter of the fibrous carbon is not particularly limited, and is, for example, 0.1 nm or more and 200 nm or less. The diameter may be 0.2 nm or more and 100 nm or less. The diameter may be 0.3 nm or more and 50 nm or less. Meanwhile, a length of the fibrous carbon is not particularly limited, and is, for example, 0.5 μm or more and 100 μm or less, and may be 1 μm or more and 50 μm or less. An aspect ratio (length/diameter) of the fibrous carbon is not particularly limited, and is, for example, 100 or more and 5,000 or less, and may be 500 or more and 4,000 or less.

A G/D ratio of the fibrous carbon is preferably high, for example, 10 or more, and may be 30 or more, 50 or more, 70 or more, or 90 or more. In addition, purity of the fibrous carbon is preferably high. The purity of the fibrous carbon obtained by thermal weight measurement is, for example, 90% or more, may be 95% or more, and may be 99% or more.

Specific examples of the fibrous carbon include a carbon nanotube (CNT) such as a single-walled carbon nanotube (SWCNT) or a multi-walled carbon nanotube (MWCNT), and a carbon nanofiber (CNF). A theoretical value of the specific surface area of the SWCNT is about 2,600 m²/g.

The electrode mixture according to the present disclosure usually contains the fibrous carbon as a main component of the conductive material. The proportion of the fibrous carbon with respect to all the conductive materials in the electrode mixture is, for example, 80 mass % or more, and may be 90 mass % or more, 95 mass % or more, or 100 mass %. Examples of the conductive material other than the fibrous carbon include particulate carbon, such as acetylene black (AB) or Ketjen black (KB).

### 2. Electrode Active Material

The electrode active material according to the present disclosure may be a positive electrode active material or a negative electrode active material. In addition, examples of the electrode active material according to the present disclosure include an oxide active material, a Si-based active material, and a carbon-based active material.

A crystal structure of the oxide active material is not particularly limited, and examples thereof include a layered rock salt crystal structure, a spinel crystal structure, and an olivine crystal structure. In addition, examples of the oxide active material include a compound (lithium composite oxide) containing an Li element, an M element, and an O element. Here, the M is metal (including semimetal) other than Li. The oxide active material may contain solely one kind of M element or may contain two or more kinds of M elements.

The M may be transition metal or may be metal (including semimetal) belonging to groups from the 13th group to the 16th group of the periodic table. The M preferably contains at least Ni. Examples of the M other than Ni include at least one of Co, Mn, Al, V, and Fe. A mole ratio of Ni to the M (Ni/M) is not particularly limited, and is, for example, 50% or more, and may be 60% or more, 70% or more, 80% or more, 90% or more. Meanwhile, Ni/M may be 100% or less, and may be less than 100%. In addition to the Li element, the M element, and the O element, the oxide active material may have a nonmetallic element such as a P element.

Examples of composition of the oxide active material include LiNiₓCo_{y}Al_{z}O₂ (0≤x≤1, 0≤y≤1, 0≤z≤1, x+y+z=1). The x may be 0.5 or more, 0.6 or more, 0.7 or more, 0.8 or more, or 0.9 or more. Meanwhile, the x may be less than 1. The y may be 0 or may be greater than 0. In addition, the y is, for example, 0.20 or less. The z may be 0 or may be greater than 0. In addition, the z is, for example, 0.10 or less.

Other examples of the composition of the oxide active material include LiNiₐCo_{b}Mn_{c}O₂ (0≤a≤1, 0≤b≤1, 0≤c≤1, a+b+c=1). The a may be 0.3 or more, 0.5 or more, 0.7 or more, or 0.9 or more. Meanwhile, the a may be less than 1. The b may be 0 or may be greater than 0. Further, the b is, for example, 0.40 or less. The c may be 0 or may be greater than 0. In addition, the c is, for example, 0.40 or less.

The electrode active material may be a Si-based active material. The Si-based active material is an active material containing Si as a main component. The Si-based active material may be Si alone, Si alloy, or a Si oxide. The Si-based active material may have a diamond crystal phase, may have a type-I clathrate crystal phase, or may have a type-II clathrate crystal phase. In the type-I or type-II clathrate crystal phase, a polyhedron (cage) including a pentagon or a hexagon is formed by a plurality of Si elements. The polyhedron has a space that can accommodate a Li ion inside, and thus a volume change due to charging and discharging can be suppressed. In addition, the Si-based active material may have a void in a primary particle. Porosity of the primary particles is, for example, 4% or more and 40% or less.

The electrode active material may be a carbon-based active material. The carbon-based active material is preferably used as a negative electrode active material, for example. Examples of the carbon-based active material include graphite, hard carbon, and soft carbon.

A shape of the electrode active material is, for example, particulate. A particle size D₅₀ of the electrode active material is, for example, 100 nm or more, and may be 1 μm or more, or 5 μm or more. Meanwhile, the particle size D₅₀ of the electrode active material is, for example, 50 μm or less, and may be 20 μm or less. In the present disclosure, the particle size D₅₀ corresponds to a particle size corresponding to the cumulative 50 volume % measured by a laser diffraction particle size distribution measurement device.

The electrode active material may be coated with a coating layer. By providing the coating layer, it is possible to reduce deterioration of the electrolyte caused by reaction between the electrode active material and the electrolyte. In particular, in a case where the electrode active material is an oxide active material and the electrode mixture contains a sulfide solid electrolyte, the electrode active material is preferably coated with the coating layer. The coating layer preferably contains a Li ion conductive oxide. Examples of the Li ion conductive oxide include a compound containing a Li element and a PO₄ structure (LPO, for example, Li₃PO₄), a compound containing a Li element, a B element, and a PO₄ structure (LBPO, for example, LiBPO₄), and a compound containing a Li element, a Nb element, and an O element (for example, LiNbO₃).

A thickness of the coating layer is not particularly limited, and is, for example, 1 nm or more and 100 nm or less, and may be 5 nm or more and 50 nm or less, or 10 nm or more and 30 nm or less. The thickness of the coating layer is obtained, for example, as an average value of thicknesses of a plurality of samples (for example, 100 or more samples) observed by a scanning electron microscope (SEM) or a transmission electron microscope (TEM). A coating rate of the coating layer with respect to the electrode active material is, for example, 70% or more, and may be 80% or more or 90% or more.

The solid content ratio of the electrode active material in the electrode mixture is, for example, 20 mass % or more, and may be 30 mass % or more or 40 mass % or more. When the solid content ratio of the electrode active material is too small, there is a possibility that a sufficient energy density cannot be obtained. Meanwhile, the solid content ratio of the electrode active material is, for example, 80 mass % or less, and may be 70 mass % or less or 60 mass % or less. When the solid content ratio of the electrode active material is too high, ion conductivity and the electron conductivity in the electrode mixture may be relatively reduced.

### 3. Solid Electrolyte

The electrode mixture may further contain a solid electrolyte. The solid electrolyte may be an organic solid electrolyte, such as a gel electrolyte, or an inorganic solid electrolyte, such as a sulfide solid electrolyte, a halide solid electrolyte, or an oxide solid electrolyte. Among them, the solid electrolyte is preferably the sulfide solid electrolyte. This is because ion conductivity is high.

The sulfide solid electrolyte usually contains at least a Li element and a S element. The sulfide solid electrolyte further preferably contains a Me element (Me is at least one of P, As, Sb, Si, Ge, Sn, B, Al, Ga, and In). The sulfide solid electrolyte may contain a halogen element such as F, Cl, Br, or I.

The sulfide solid electrolyte may be a glass-based (amorphous) sulfide solid electrolyte, may be a glass-ceramic-based sulfide solid electrolyte, or may be a crystalline sulfide solid electrolyte. The sulfide solid electrolyte may have a crystal phase. Examples of the crystal phase include a Thio-LISICON crystal phase, an argyrodite crystal phase, and an LGPS crystal phase.

Composition of the sulfide solid electrolyte is not particularly limited, and thereof include xLi₂S·(1−x)P₂S₅ (0.5≤x<1) and examples yLiI·zLiBr·(100−y−z) (xLi₂S·(1−x)P₂S₅) (0.5≤x<1, 0≤y≤30, 0≤z≤30). In the compositions, the x preferably satisfies a relationship of 0.7≤x≤0.8. Other examples of the composition of the sulfide solid electrolyte include Li_{7-x-2y}PS_{6-x-y}X_{y}. The X is at least one of F, Cl, Br, and I, and the x and y satisfy relationships of 0≤x and 0≤y. Other examples of the composition of the sulfide solid electrolyte include Li₄₋ₓMe₁₋ₓPₓS₄ (0<x<1). The Me is at least one of Al, Zn, In, Ge, Si, Sn, Sb, Ga, and Bi.

The solid content ratio of the solid electrolyte in the electrode mixture is, for example, 10 mass % or more and 50 mass % or less, and may be 20 mass % or more and 40 mass % or less.

### 4. Other Components

The electrode mixture may further contain a binder. Examples of the binder include a rubber-based binder, such as butadiene rubber (BR) or styrene-butadiene rubber (SBR), and a fluoride-based binder, such as polyvinylidene fluoride (PVdF). The solid content ratio of the binder in the electrode mixture is, for example, 0.1 mass % or more and 5 mass % or less.

The electrode mixture may further contain a dispersion medium or may not contain a dispersion medium. Examples of the dispersion medium include butyl acetate, butyl butanoate, mesitylene, tetralin, heptane, and N-methyl-2-pyrrolidone (NMP). In a case where the electrode mixture contains the dispersion medium, the solid content ratio of the electrode mixture is, for example, 20 mass % or more and 80 mass % or less.

### 5. Electrode Mixture

The electrode mixture according to the present disclosure may be a positive electrode mixture containing a positive electrode active material as the electrode active material, or a negative electrode mixture containing a negative electrode active material as the electrode active material, but the former is preferable. In addition, the electrode mixture according to the present disclosure is used, for example, in a battery. The battery will be described in “C. Battery” below.

### B. Electrode Layer

The electrode layer according to the present disclosure contains the electrode mixture as described in “A. Electrode Mixture”.

According to the present disclosure, the electrode mixture is used, whereby the electrode layer is provided, in which the initial resistance can be reduced even when the content of the conductive material in the electrode layer is reduced. The electrode mixture contained in the electrode layer is the same as the content described in “A. Electrode Mixture”. The electrode layer according to the present disclosure may be a positive electrode layer or a negative electrode layer.

A filling ratio of the electrode layer is not particularly limited, and is, for example, less than 93%, 92% or less, or 90% or less. Here, in an electrode layer of a solid-state battery, electrons and ions are conducted through a solid-solid interface, and thus, from the viewpoint of securing a conduction path, the filling ratio of the electrode layer is generally preferably high. Meanwhile, in order to increase the filling ratio, for example, a pressing temperature needs to be increased, and equipment for that purpose is needed. Regarding this, by using the electrode mixture, the initial resistance can be reduced as in a case where the filling ratio of the electrode layer is high, even in a case where the filling ratio of the electrode layer is low. Therefore, it is possible to reduce an equipment cost or to simplify the manufacturing process. Meanwhile, the filling ratio of the electrode layer is, for example, 75% or more, and may be 77% or more, or 79% or more.

A thickness of the electrode layer is not particularly limited, and is, for example, 0.1 μm or more and 1,000 μm or less, and may be 1 μm or more and 500 μm or less, or 5 μm or more and 100 μm or less. In addition, the electrode layer according to the present disclosure is used, for example, in a battery. The battery will be described in “C. Battery” below.

### C. Battery

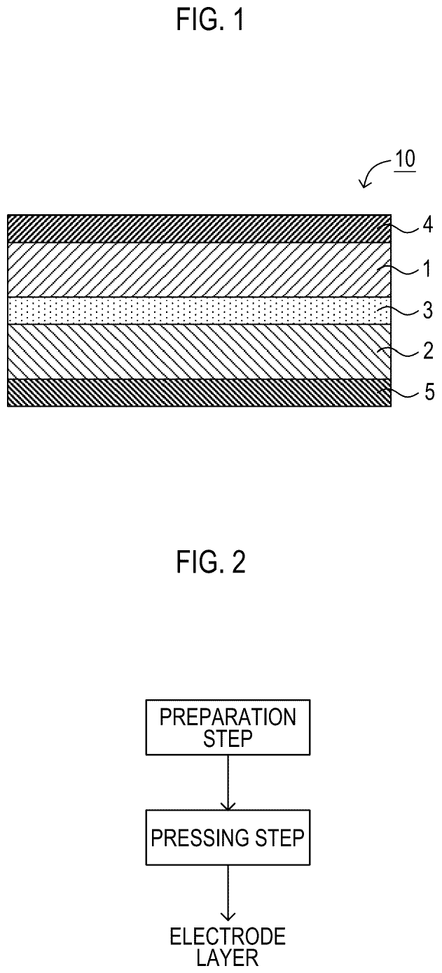

FIG. 1 is a schematic sectional view illustrating the battery according to the present disclosure. A battery 10 shown in FIG. 1 includes a positive electrode layer 1, a negative electrode layer 2, an electrolyte layer 3 disposed between the positive electrode layer 1 and the negative electrode layer 2, a positive electrode current collector 4 that collects a current of the positive electrode layer 1, and a negative electrode current collector 5 that collects a current of the negative electrode layer 2. In the present disclosure, the positive electrode layer 1 or the negative electrode layer 2 is the electrode layer described in “B. Electrode Layer”.

According to the present disclosure, the electrode layer is used, whereby the battery is provided, in which the initial resistance can be reduced even when the content of the conductive material in the electrode layer is reduced. As described above, the electrode layer may be a positive electrode layer or may be a negative electrode layer.

### 1. Positive Electrode Layer

A positive electrode layer according to the present disclosure may be the electrode layer described in “B. Electrode Layer”. The electrode layer is the same as the content described in “B. Electrode Layer”, and thus the description thereof will be omitted. Meanwhile, in a case where a negative electrode layer to be described later is the electrode layer described in “B. Electrode Layer”, any positive electrode layer can be adopted as the positive electrode layer.

### 2. Negative Electrode Layer

The negative electrode layer according to the present disclosure may be the electrode layer described in “B. Electrode Layer”. The electrode layer is the same as the content described in “B. Electrode Layer”, and thus the description thereof will be omitted. Meanwhile, in a case where the positive electrode layer is the electrode layer described in “B. Electrode Layer”, any negative electrode layer can be adopted as the negative electrode layer.

### 3. Electrolyte Layer

An electrolyte layer is a layer formed between the positive electrode layer and the negative electrode layer, and contains at least an electrolyte. The electrolyte may be a solid electrolyte or may be a liquid electrolyte (electrolytic solution). Among them, the electrolyte layer preferably contains a solid electrolyte, and more preferably contains a solid electrolyte as a main component of the electrolyte.

The solid electrolyte is the same as the content described in “A. Electrode Mixture”, and thus the description thereof will be omitted. Meanwhile, the electrolytic solution preferably contains a supporting salt and a solvent. Examples of the supporting salt (lithium salt) of the electrolytic solution having lithium ion conductivity include inorganic lithium salts, such as LiPF₆, LiBF₄, LiClO₄, and LiAsF₆, and organic lithium salts, such as LiCF₃SO₃, LiN(CF₃SO₂)₂, LiN(C₂F₅SO₂)₂, LiN(FSO₂)₂, and LiC(CF₃SO₂)₃. Examples of the solvent used for the electrolytic solution include cyclic ester (cyclic carbonate) such as ethylene carbonate (EC), propylene carbonate (PC), or butylene carbonate (BC), and chain esters (chain carbonate) such as dimethyl carbonate (DMC), diethyl carbonate (DEC), or ethyl methyl carbonate (EMC). The electrolytic solution preferably contains two or more solvents.

A thickness of the electrolyte layer is not particularly limited, and is, for example, 0.1 μm or more and 1,000 μm or less, and may be 1 μm or more and 500 μm or less, or may be 5 μm or more and 100 μm or less.

### 4. Other Configurations

The battery according to the present disclosure preferably includes a positive electrode current collector that collects a current of the positive electrode layer and a negative electrode current collector that collects a current of the negative electrode layer. Examples of a material for the positive electrode current collector include SUS, aluminum, nickel, iron, titanium, and carbon. Meanwhile, examples of a material for the negative electrode current collector include SUS, copper, nickel, and carbon.

The battery according to the present disclosure may further include a restraining jig that applies a restraining pressure along a thickness direction to the positive electrode layer, the electrolyte layer, and the negative electrode layer. In particular, in a case where the electrolyte layer contains a solid electrolyte, it is preferable to apply a restraining pressure in order to form a good ion conduction path. The restraining pressure is, for example, 0.1 MPa or more, and may be 1 MPa or more or may be 5 MPa or more. Meanwhile, the restraining pressure is, for example, 100 MPa or less, and may be 50 MPa or less or may be 20 MPa or less.

### 5. Battery

A type of the battery according to the present disclosure is not particularly limited, but is typically a lithium-ion battery. The battery according to the present disclosure may be a liquid battery containing an electrolytic solution as the electrolyte layer, or a solid-state battery having a solid electrolyte layer as the electrolyte layer. The solid-state battery may be a semi-solid-state battery or may be an all-solid-state battery. In addition, the battery according to the present disclosure may be a primary battery or may be a secondary battery, but the battery is preferably a secondary battery. It is because a secondary battery can be repeatedly charged and discharged and is useful, for example, as an in-vehicle battery.

Examples of use of the battery include a power source of a vehicle, such as a hybrid electric vehicle (HEV), a plug-in hybrid electric vehicle (PHEV), a battery electric vehicle (BEV), a gasoline vehicle, or a diesel vehicle. In particular, the battery is preferably used as a drive power source for a hybrid electric vehicle (HEV), a plug-in hybrid electric vehicle (PHEV), or a battery electric vehicle (BEV). The battery may be used as a power source of a moving body other than a vehicle (for example, a train, a ship, or an airplane), or may be used as a power source of an electrical product, such as an information processing device.

### D. Manufacturing Method of Electrode Layer

FIG. 2 is a flowchart illustrating a manufacturing method of the electrode layer according to the present disclosure. In the manufacturing method of the electrode layer shown in FIG. 2, first, the electrode mixture described in “A. Electrode Mixture” is prepared (a preparation step). Next, the electrode mixture is pressed at a temperature of 0° C. or higher and 30° C. or lower to obtain the electrode layer (a pressing step).

According to the present disclosure, the electrode mixture is used, whereby the electrode layer having the reduced initial resistance can be obtained even in a case where pressing is performed at a temperature near a room temperature.

### 1. Preparation Step

The preparation step according to the present disclosure is a step of preparing the electrode mixture. The electrode mixture is the same as the content described in “A. Electrode Mixture”. The electrode mixture may contain a dispersion medium or may not contain a dispersion medium.

### 2. Pressing Step

The pressing step in the present disclosure is a step of pressing the electrode mixture at a temperature of 0° C. or higher and 30° C. or lower to obtain the electrode layer.

For example, in a case where the electrode mixture contains a dispersion medium (in a case where the electrode mixture is slurry), the slurry is applied and dried, and then a precursor layer is formed and the precursor layer is pressed. The precursor layer is formed, for example, on an electrode current collector. On the other hand, in a case where the electrode mixture does not contain a dispersion medium, a powdery electrode mixture is pressed. The powdery electrode mixture is disposed, for example, on the electrode current collector.

Examples of the method of pressing the electrode mixture include a roll pressing and a flat plate pressing. A pressing pressure for pressing the electrode mixture is not particularly limited, and is preferably selected such that a predetermined filling ratio is obtained.

The present disclosure is not limited to the embodiment. The embodiment is an example and anything that has substantially the same configuration as the technical idea described in the claims of the present disclosure and produces the same effect is included in the technical scope of the present disclosure.

### Example 1

### Production of Positive Electrode Active Material

In a reaction container, 2.5 L of an ammonia aqueous solution having a concentration of 5 g/L was prepared, and while a temperature inside the tank was kept at 40° C., an initial aqueous solution was prepared using a sodium hydroxide aqueous solution such that pH was 11.5 at a liquid temperature of 25° C. as a reference. Next, nickel sulfate, cobalt sulfate, and aluminum sulfate were dissolved in pure water such that a relationship of Ni:Co:A1=0.82:0.15:0.03 is satisfied in terms of mole ratio to prepare a mixed aqueous solution having a concentration of 2.0 mol/L.

The mixed aqueous solution was dropped at a constant rate into the initial aqueous solution in the reaction tank to form a precipitate, and the recovered slurry was filtered and washed, and then dried, thereby a precursor was obtained. The obtained precursor and Li₂CO₃ were mixed such that a relationship of Li:(Ni+Co+Al)=1.1:1 is satisfied in terms of mole ratio, and the mixture was fired under conditions of an oxygen atmosphere, 750° C., and 10 hours. As a result, a positive electrode active material was obtained.

### Production of Coating Positive Electrode Active Material

In 166.0 g of ion-exchanged water, 10.8 g of a metaphosphoric acid (manufactured by FUJIFILM Wako Pure Chemical Corporation) was dissolved. Next, a coating liquid was obtained by adding lithium hydroxide monohydrate such that a relationship of Li:P=0.45:1 is satisfied in terms of mole ratio. Next, 53.7 g of the coating liquid was added to 50.0 g of the positive electrode active material to produce slurry, and a coating positive electrode active material was obtained by spray drying the slurry.

### Production of Positive Electrode

The coating positive electrode active material and a sulfide solid electrolyte (Li₂S—P₂S₅-based glass ceramic including LiI, D₅₀=0.8 μm) were weighed such that a relationship of coating positive electrode active material:sulfide solid electrolyte=75:25 is satisfied in terms of volume ratio, and the coating positive electrode active material and the sulfide solid electrolyte were put into tetralin together with a conductive material (single-walled carbon nanotube, specific surface area=2000 m²/g) and a binder (butadiene rubber). Next, a positive electrode mixture was obtained by mixing these. A proportion of the conductive material in a solid content of the positive electrode mixture was 0.1 mass %.

The obtained positive electrode mixture was sufficiently dispersed using an ultrasonic homogenizer (UH-50 manufactured by SMT Co., Ltd.), and then applied on a positive electrode current collector (aluminum foil) and dried at 100° C. for 30 minutes. Thereafter, a positive electrode was obtained by punching the positive electrode mixture to a size of 1 cm².

### Production of Negative Electrode

A sulfide solid electrolyte (Li₂S—P₂S₅-based glass ceramic including LiI, D₅₀=0.8 μm), 1 mass % of a conductive material (vapor-phase growth carbon fiber), 2 mass % of a binder (butadiene rubber), and a dispersion medium (heptane) were put into a kneading container of a Filmix device (Model 30-L manufactured by PRIMIX Corporation), and stirred under conditions of 20,000 rpm and 30 minutes. Next, a negative electrode active material (Li₄Ti₅O₁₂ particles, D₅₀=1 μm) was put into the kneading container such that a volume ratio to the sulfide solid electrolyte was 70:30, and the mixture was stirred in the Filmix device under conditions of 15,000 rpm and 60 minutes to obtain a negative electrode mixture.

The obtained negative electrode mixture was applied on a negative electrode current collector (copper foil) and dried at 100° C. for 30 minutes. Thereafter, a negative electrode was obtained by punching the negative electrode mixture to a size of 1 cm².

Production of Solid Electrolyte Layer A sulfide solid electrolyte (Li₂S—P₂S₅-based glass ceramic including LiI, D₅₀=2.5 μm) was put into a cylindrical ceramic having an inner diameter sectional area of 1 cm² by 64.8 mg and smoothed. Next, a solid electrolyte layer was obtained by pressing the electrolyte at a pressure of 1 ton/cm².

### Production of Battery

The positive electrode was disposed on one surface of the obtained solid electrolyte layer, and the negative electrode was superimposed on the other surface of the solid electrolyte layer, and was pressed under conditions of a room temperature (25° C.), 6 ton/cm², and 1 minute. Next, a stainless-steel bar was disposed on each of both electrodes, and the electrodes were restrained at a restraining pressure of 1 ton to obtain an all-solid-state battery.

### Example 2

An all-solid-state battery was obtained in the same manner as in Example 1, except that the proportion of the conductive material in the solid content of the positive electrode mixture was changed to 0.3 mass %.

### Example 3

An all-solid-state battery was obtained in the same manner as in Example 1, except that the proportion of the conductive material in the solid content of the positive electrode mixture was changed to 1.0 mass %.

### Example 4

An all-solid-state battery was obtained in the same manner as in Example 1, except that the conductive material added to the positive electrode was changed to single-walled carbon nanotubes having a specific surface area of 400 m²/g, and the proportion of the conductive material in the solid content of the positive electrode mixture was changed to 0.3 mass %.

### Comparative Example 1

An all-solid-state battery was obtained in the same manner as in Example 1, except that the proportion of the conductive material in the solid content of the positive electrode mixture was changed to 1.1 mass %.

### Comparative Example 2

An all-solid-state battery was obtained in the same manner as in Example 1, except that the conductive material added to the positive electrode was changed to a vapor-phase growth carbon fibers having a specific surface area of 13 m²/g, and the proportion of the conductive material in the solid content of the positive electrode mixture was changed to 2.0 mass %.

### Comparative Example 3

An all-solid-state battery was obtained in the same manner as in Comparative Example 2, except that the proportion of the conductive material in the solid content of the positive electrode mixture was changed to 3.2 mass %.

### Comparative Example 4

An all-solid-state battery was obtained in the same manner as in Comparative Example 2, except that the pressing temperature was changed from room temperature to 150° C. during the production of the battery.

### Evaluation

### Evaluation of Battery

The all-solid-state batteries obtained in Examples 1 to 4 and Comparative Examples 1 to 4 were subjected to two cycles of constant current-constant voltage charging and discharging at a set voltage of 2.8 V or 1.5 V and a ⅓ C rate. Next, SOC was adjusted to 40% at a ⅓ C rate. The battery was discharged with a direct current at a 2.5 C rate in a constant temperature tank held at 25° C., and a resistance value was calculated from a voltage drop amount and an applied current 5 seconds after 0 seconds. Table 1 shows the result. In Table 1, a resistance value in Comparative Example 2 was set to a reference of 1.00, and a resistance value of each of Examples and Comparative Examples was relatively evaluated.

Next, a cycle test of 60° C., 1 C, SOC: 0% to 100%, and 100 cycles was performed, discharge resistance was measured again after the cycle test, and a resistance increase rate before and after the cycle test was calculated. Table 1 shows the result. In Table 1, a resistance increase rate in Comparative Example 2 was set to a reference of 1.00, and a resistance increase rate of each of Examples and each of Comparative Examples was relatively evaluated.

### Measurement of Filling Ratio

Masses of the positive electrodes (positive electrode obtained by punching to the size of 1 cm²) produced in Examples 1 to 4 and Comparative Examples 1 to 4 were measured, thicknesses of the positive electrodes pressed under the same conditions as in the production of the battery was measured using a film thickness meter, a density of the positive electrode mixture was obtained, and filling ratios of the positive electrode layers was obtained from a true density of each member that was put in and the positive electrode mixture composition. Table 1 shows the result.

TABLE 1

| | Conductive material | | | | | | | Resistance |
|---|---|---|---|---|---|---|---|---|
| | | Specific | Solid | | | | Initial | increase |
| | | surface | content | | Filling | | resistance | rate |
| | | area X | ratio Y | | ratio | Pressing | [relative | [relative |
| | Type | [m²/g] | [mass %] | XY | [%] | temperature | value] | value] |
| Example 1 | SWCNT | 2000 | 0.1 | 200 | 85 | Room | 0.76 | 0.93 |
| | | | | | | temperature | | |
| Example 2 | SWCNT | 2000 | 0.3 | 600 | 80 | Room | 0.78 | 0.98 |
| | | | | | | temperature | | |
| Example 3 | SWCNT | 2000 | 1.0 | 2000 | 86 | Room | 0.78 | 1.06 |
| | | | | | | temperature | | |
| Example 4 | SWCNT | 400 | 0.3 | 120 | 85 | Room | 0.85 | 1.03 |
| | | | | | | temperature | | |
| Comparative | SWCNT | 2000 | 1.1 | 2200 | 80 | Room | 0.79 | 1.23 |
| Example 1 | | | | | | temperature | | |
| Comparative | VGCF | 13 | 2.0 | 26 | 81 | Room | 1.00 | 1.00 |
| Example 2 | | | | | | temperature | | |
| Comparative | VGCF | 13 | 3.2 | 41.6 | 88 | Room | 0.86 | 1.21 |
| Example 3 | | | | | | temperature | | |
| Comparative | VGCF | 13 | 2.0 | 26 | 93 | 150° C. | 0.77 | 0.99 |
| Example 4 | | | | | | | | |

As shown in Table 1, it was confirmed that Examples 1 to 4 have a lower initial resistance than Comparative Example 2 and have a resistance increase rate of the same level or less. In particular, in Examples 1 and 2, the initial resistance and the resistance increase rate were significantly reduced as compared with Comparative Example 2. On the other hand, in Comparative Example 1, the initial resistance is low as compared with Comparative Example 2, but the resistance increase rate is high. This is considered to be because, in a case where the conductive material having the large specific surface area X is used, an influence of the deterioration of the solid electrolyte due to the reaction of the conductive material and the solid electrolyte appears unless the solid content ratio Y is made smaller.

In addition, in Comparative Example 2, the initial resistance was higher as compared with Examples 1 to 4. This is considered to be because the electron conduction path in the positive electrode layer was insufficient. Meanwhile, in Comparative Example 3, the initial resistance was lower than that in Comparative Example 2. This is considered to be because the solid content ratio Y in Comparative Example 3 was larger than the solid content ratio Y in Comparative Example 2. However, in Comparative Example 3, since the solid content ratio Y is larger than that in Comparative Example 2, it is considered that the deterioration of the solid electrolyte was caused by the reaction of the conductive material and the solid electrolyte, and as a result, the resistance increase rate was increased.

In addition, in Comparative Example 4, the pressing temperature was 150° C., and the filling ratio was higher than those in Examples 1 to 4 and Comparative Examples 1 to 3. In the electrode layer of the solid-state battery, electrons and ions are conducted through the solid-solid interface, and thus, from the viewpoint of securing a conduction path, the filling ratio of the electrode layer is generally preferably high. Meanwhile, in order to increase the filling ratio, for example, a pressing temperature needs to be increased, and the equipment for that purpose is needed. Regarding this, in Examples 1 to 3, a remarkable effect was obtained in that the initial resistance was the same as that in Comparative Example 4 even though the pressing temperature was room temperature. In particular, in Examples 1 and 2, a more remarkable effect was obtained in that the initial resistance and the resistance increase rate were the same as those in Comparative Example 4 even though the pressing temperature was room temperature.

What is claimed is:

1. An electrode mixture comprising:
an electrode active material; and
fibrous carbon as a conductive material, wherein
in a case where a specific surface area of the fibrous carbon is denoted by X m²/g and a solid content ratio of the fibrous carbon in the electrode mixture is denoted by Y mass %,
a product of the X and the Y is greater than 42 and smaller than 2200; and
the Y is 2.0 mass % or less.

2. The electrode mixture according to claim 1, wherein the product of the X and the Y is greater than 120 and smaller than 2000.

3. The electrode mixture according to claim 1, wherein the X is 350 m²/g or more.

4. The electrode mixture according to claim 1, wherein the fibrous carbon is a single-walled carbon nanotube.

5. The electrode mixture according to claim 1, further comprising a solid electrolyte.

6. The electrode mixture according to claim 1, wherein the electrode active material has a layered rock salt crystal structure.

7. An electrode layer comprising the electrode mixture according to claim 1.

8. The electrode layer according to claim 7, wherein a filling ratio of the electrode layer is less than 93%.

9. The electrode layer according to claim 7, wherein a filling ratio of the electrode layer is 75% or more.

10. The electrode layer according to claim 7, wherein the electrode layer is a positive electrode layer.

11. A battery comprising:
a positive electrode layer;
a negative electrode layer; and
an electrolyte layer disposed between the positive electrode layer and the negative electrode layer, wherein
the positive electrode layer or the negative electrode layer is the electrode layer according to claim 7.

12. The battery according to claim 11, wherein the electrolyte layer contains a solid electrolyte.

13. The battery according to claim 11, wherein the positive electrode layer is the electrode layer.
